(19) United States
(12) Patent Application Publication
(10) Pub. No.: US 2025/0010237 A1
(43) Pub. Date: Jan. 9, 2025

(54) CARBON DIOXIDE CAPTURE IN WATER SYSTEM AND METHOD

(71) Applicant: CATAGEN LIMITED, Belfast, Antrim (GB)

(72) Inventors: Andrew WOODS, Belfast, Antrim (GB); Roy DOUGLAS, Belfast, Antrim (GB); Matthew ELLIOT, Belfast, Antrim (GB)

(21) Appl. No.: 18/712,320

(22) PCT Filed: Nov. 22, 2022
(86) PCT No.: PCT/EP2022/082885

§ 371 Date: May 22, 2024

(30) Foreign Application Priority Data
Nov. 22, 2021 (GB) 2116819.0

(51) Int. Cl. B01D 53/14; B01D 53/18

(52) U.S. Cl. CPC B01D 53/1475; B01D 53/1425; B01D 53/1493; B01D 53/18; B01D 2252/103; B01D 2257/504; B01D 2258/06

(57) ABSTRACT

The carbon dioxide capture system 100 comprises an absorption tank 102 arranged to store a body of water. The absorption tank 102 comprises a gas inlet 104 via which gas (e.g. atmospheric air) is delivered to the tank 102 to allow for carbon dioxide contained within the gas to dissolve into the body of water. The system 100 further comprises a first fluid delivery means 114 arranged to withdraw water from the absorption tank 102. The withdrawn water may be delivered to a desorption tank 118 via a heat transfer unit 116 to allow for the withdrawn water to be heated to a higher temperature. A heater 122 may also raise the temperature of the water further. The warmed water releases carbon dioxide gas into the desorption tank 118.

The present disclosure is directed towards a carbon dioxide capture system and method of capturing carbon dioxide. The system and method may utilise atmospheric air and capture the carbon dioxide gas in a body of water.

### BACKGROUND

Known methods for sequestering or capturing carbon dioxide from the atmosphere use either complex chemical processes or membrane separation of gases using gas compressors to pump the air. These methods are relatively inefficient, expensive to manufacture and have not been widely deployed.

It is an object of the present disclosure to provide an improved carbon dioxide capture system.

### SUMMARY

There is provided a carbon dioxide capture system and method as set out in the accompanying claims. Other features of the invention will be apparent from the dependent claims, and the description which follows.

According to a first aspect of the disclosure, there is provided a carbon dioxide capture system. The carbon dioxide capture system comprises an absorption tank arranged to store a body of water. The absorption tank comprising a gas inlet via which gas is delivered to the tank to allow for carbon dioxide contained within the gas to dissolve into the body of water. The carbon dioxide capture system also comprises a first fluid delivery means arranged to withdraw water from the absorption tank. The carbon dioxide capture system further comprises a heat transfer unit comprising a connection means for receiving waste/excess heat from another process.

In the present application, the term ‘water’ is to be given a broader meaning than only pure H₂O (although pure H₂O can also be used), it may include solutions which contain water and any additional constituents either occurring naturally (for example, in sea water), or having been added artificially, for the purposes of achieving superior results for the processes disclosed herein. The any additional constituents described may be any which achieve a superior result for the processes disclosed, in particular: atoms, ions, molecules, compounds and salts in any of gas, liquid or solid states; the constituents being either on their own or in a combination thereof.

Advantageously, the absorption tank stores a body of water to capture carbon dioxide contained within gas delivered to the absorption tank. The water containing the captured carbon dioxide is able to be withdrawn from the absorption tank using the fluid delivery means. The fluid delivery means may be a pump. This provides a simple and effective mechanism for capturing carbon dioxide. The gas may be air (e.g. atmospheric air).

The carbon dioxide capture system may comprise a gas delivery means arranged to deliver the gas to the tank via the gas inlet. The gas delivery means may be a compressor. The gas delivery means enables the gas to be compressed and pumped into the absorption tank to enhance the efficiency of the carbon dioxide capture.

The absorption tank may have a volume of at least 10 m3. The absorption tank may have a volume of at least 20 m3. The absorption tank may have a volume of at least 30 m3. The absorption tank may have a volume of at least 40 m3. The absorption tank may have a volume of at least 50 m3. The absorption tank may have a volume of between 10 m3 and 50 m3. It will of course be appreciated that tanks having a volume smaller than 10 m3 can be used for certain applications. The absorption tank may comprise one or more perforated tubes which receive the gas and enable the gas to bubble into the body of water.

The body of water may be stored at a temperature of less than 25 degrees Centigrade. The solubility of gases such as carbon dioxide into water is higher at low temperatures. Storing the body of water at less than 25 degrees improves the absorption efficiency. Alternatively, if the system is using waste heat a lower control temperature of more than 25 degrees Centigrade may still work. For example a 1 m3 vessel can store 1.3 kg CO2 at 30 degrees Centigrade.

The body of water may be stored at a temperature of less than 20 degrees Centigrade. The body of water may be stored at a temperature of less than 15 degrees Centigrade. The body of water may be stored at a temperature of less than 10 degrees Centigrade. The body of water may be stored at a temperature of less than 5 degrees Centigrade.

The body of water may be stored at a temperature of greater than 0 degrees Centigrade.

The body of water may be stored at a temperature of between 0 degrees Centigrade and 25 degrees Centigrade. The body of water may be stored at a temperature of between 0 degrees Centigrade and 20 degrees Centigrade.

The carbon dioxide capture system may further comprise a cooler arranged to maintain the temperature of the body of water at a temperature of less than 25 degrees Centigrade or any other temperature as described above. The cooler may be separate to the absorption tank or incorporated into the absorption tank. When the cooler is separate to the absorption tank, the cooler is arranged to cool water prior to the water entering the absorption tank. When the cooler is incorporated into the absorption tank, the cooler is arranged to cool water in the absorption tank. The cooler may be controlled by a control system to maintain the desired temperature.

The carbon dioxide capture system may further comprise a heat transfer unit arranged to receive water from the first fluid delivery means and transfer heat to the water to raise the temperature of the water.

Advantageously, the heat transfer unit is able to warm water that has been withdrawn from the absorption tank. Raising the temperature of the water facilitates the release of carbon dioxide gas from the water. The released carbon dioxide gas can be stored in storage tanks for use in various applications. The heat transfer unit may use waste heat such as from warmed water returning to the absorption tank. The heat transfer unit therefore provides high energy efficiency heat regeneration.

The heat transfer unit may comprise a heat exchanger. Optionally, waste heat from a separate process can be used.

The heat transfer unit may comprise a heat pump.

In one embodiment, the carbon dioxide is removed from the system in the heat transfer unit.

The carbon dioxide capture system may further comprise a desorption tank arranged to receive water from the absorption tank to allow for carbon dioxide gas to be released from the water. The released carbon dioxide gas can be stored in storage tanks for use in various applications.

The desorption tank may have a volume of at least 10 m3. The desorption tank may have a volume of at least 20 m3. The desorption tank may have a volume of at least 30 m3. The desorption tank may have a volume of at least 40 m3. The desorption tank may have a volume of at least 50 m3. The desorption tank may have a volume of between 10 m3 and 50 m3.

The carbon dioxide capture system may further comprise a second fluid delivery means arranged to withdraw water from the desorption tank for recirculation to the absorption tank or rejection from the system. The carbon dioxide capture system may further comprise a heat transfer unit arranged to receive (cold) water from the first fluid delivery means and (warm) water from the second fluid delivery means. The heat from the (warm) water received from the second fluid delivery means is transferred to the (cold) water received from the first fluid delivery means to advantageously cool water being delivered to the absorption tank and heat water being delivered to the desorption tank. This provides an energy efficient mechanism for aiding in maintaining the temperature of the water in the absorption and desorption tanks at the required temperatures.

The water is in the desorption tank may be stored at a temperature greater than that of the water stored in the absorption tank. The solubility of gases such as carbon dioxide decreases as the temperature of the water increases. Storing the water at a higher temperature enables the captured carbon dioxide to be released form the water.

The water in the desorption tank may be stored at a temperature of greater than 20 degrees Centigrade.

The water in the desorption tank may be stored at a temperature of greater than 30 degrees Centigrade.

The water in the desorption tank may be stored at a temperature of greater than 40 degrees Centigrade.

The water in the desorption tank may be stored at a temperature of greater than 50 degrees Centigrade.

The water in the desorption tank may be stored at a temperature of greater than 60 degrees Centigrade.

The water in the desorption tank may be stored at a temperature of less than 70 degrees Centigrade.

The water in the desorption tank may be stored at a temperature of less than 60 degrees Centigrade.

The water in the desorption tank may be stored at a temperature of less than 50 degrees Centigrade.

The water in the desorption tank may be stored at a temperature between 20 degrees Centigrade and 60 degrees Centigrade. The water in the desorption tank may be stored at a temperature of between 20 degrees Centigrade and 50 degrees Centigrade.

The carbon dioxide capture system may further comprise a heater arranged to maintain the temperature of the water in the desorption tank at a temperature greater than water stored in the absorption tank. The temperature may be a temperature of greater than 20 degrees Centigrade or any other temperature as described above. The heater may be separate to the desorption tank or incorporated into the desorption tank. When the heater is separate to the desorption tank, the heater is arranged to heat water prior to the water entering the desorption tank. When the heater is incorporated into the desorption tank, the heater is arranged to heat water in the desorption tank. The heater may be controlled by a control system to maintain the desired temperature.

The desorption tank may comprise a gas outlet via which carbon dioxide gas is able to be withdrawn from the desorption tank. The carbon dioxide capture system may comprise a gas delivery means arranged to withdraw gas from the desorption tank via the gas outlet. The gas delivery means may be a compressor. The gas delivery means enables the gas to be compressed and pumped into one or more storage tanks.

The water may be sea water but this is not required in all examples. Fresh water or another source of water may also be used.

According to a second aspect of the disclosure, there is provided a method of capturing carbon dioxide. The method comprises delivering gas to an absorption tank storing a body of water to allow for carbon dioxide contained within the gas to dissolve into the body of water. The method also comprises withdrawing water comprising dissolved carbon dioxide from the absorption tank. The method further comprises receiving waste/excess heat from another process via a heat transfer unit comprising a connection means.

The method may comprise maintaining the body of water at a temperature of less than 25 degrees Centigrade.

The method may comprise delivering the water withdrawn from the absorption tank to a heat transfer unit to allow for heat to be transferred to the water.

The method may comprise delivering the water withdrawn from the absorption tank to a desorption tank. The method may comprise heating the water withdrawn from the absorption tank so that the water in the desorption tank is maintained at a higher temperature than that of the water stored in the absorption tank. The water in the desorption tank may be maintained at a temperature of greater than 20 degrees Centigrade.

The method may comprise withdrawing water from the desorption tank for recirculation to the absorption tank.

The method may comprise delivering the (cold) water withdrawn from the absorption tank to a heat transfer unit and delivering the (warm) water withdrawn from the desorption tank to the heat transfer unit. This allows for heat from the (warm) water withdrawn from the desorption tank to be transferred to the (cold) water withdrawn from the absorption tank.

The method may comprise withdrawing carbon dioxide gas from the desorption tank.

According to a third aspect of the disclosure, there is provided a carbon dioxide capture system. The carbon dioxide capture system comprises a desorption tank comprising a fluid inlet arranged to receive water comprising captured carbon dioxide. The carbon dioxide capture system comprises a heater arranged to heat the water to a temperature to allow for carbon dioxide to be released from the water. The desorption tank comprises a gas outlet via which carbon dioxide gas may be withdrawn from the desorption tank.

Advantageously, water comprising carbon dioxide is heated and is stored in a desorption tank to allow for carbon dioxide gas stored in the water to be released and captured in the desorption tank. The captured carbon dioxide gas is able to be withdrawn via the gas outlet and stored for use in various applications.

Ideally, heating can be provided through passive waste heat recovery from a separate process. This separate process could be power generation or industrial process low grade heat.

### BRIEF DESCRIPTION OF THE DRAWINGS

Examples of the present disclosure will now be described with reference to the accompanying drawings, in which:

FIGS. 1 and 2 show schematic diagrams of example carbon dioxide capture systems according to aspects of the present disclosure;

FIG. 3 shows a schematic diagram of an example control system for controlling a carbon dioxide capture system according to aspects of the present disclosure; and

FIG. 4 shows a flow diagram of an example method according to aspects of the present disclosure.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise.

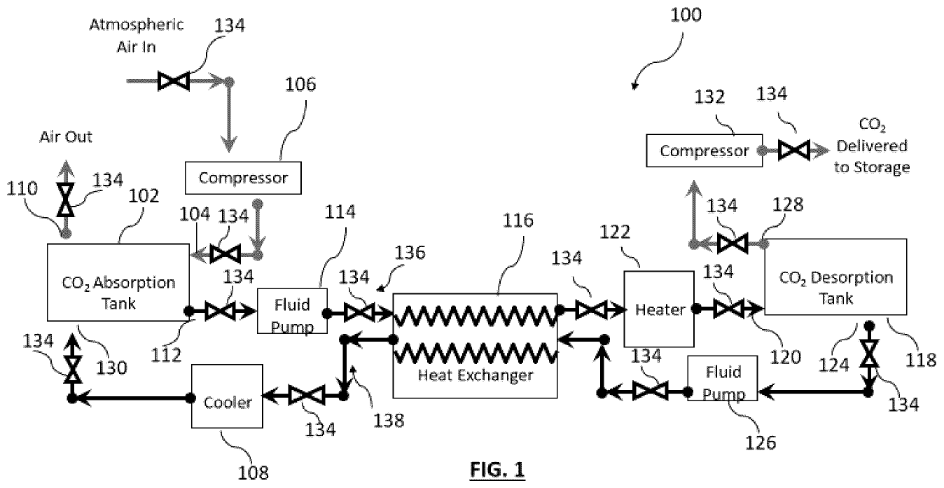

Referring to FIG. 1, there is shown a carbon dioxide capture system 100 according to aspects of the present disclosure.

The carbon dioxide capture system 100 comprises a carbon dioxide absorption tank 102 arranged to store a body of water. The absorption tank 102 has a volume of between 10 m3 and 50 m3.

The absorption tank 102 comprises a gas inlet 104 via which gas is delivered to the absorption tank 104. The gas may be air such as atmospheric air. Alternatively, the gas may be any gas containing CO2 such as the exhaust from a power station. Beneficially, the capture system 100 is able to capture carbon dioxide from atmospheric air so as to help mitigate or reverse climate change.

The carbon dioxide contained within the gas is able to dissolve into the body of water. This enables the carbon dioxide contained within the gas to be captured in the body of water. The absorption tank 102 may comprise one or more perforated tubes through which the gas is able to flow and bubble out into the body of water.

The carbon dioxide capture system 100 comprises a gas delivery means 106 arranged to deliver the gas to the absorption tank 102. The gas deliver means 106 delivers the gas to the gas inlet 104. The gas delivery means 106 in this example comprises a compressor.

The body of water is stored at a temperature that corresponds to atmospheric air temperature or at a temperature below atmospheric air temperature. The body of water may be stored at a temperature of less than 25 degrees Centigrade, and preferably less than 20 degrees Centigrade. The body of water may be stored at a temperature of between 0 degrees Centigrade and 20 degrees Centigrade. Alternatively, the body of water may be stored at temperatures greater than 25 degrees Centigrade depending on where the system is operating. These higher temperatures may be suitable where the system is operating using waste heat from another process.

Advantageously, the solubility of gases such as carbon dioxide are higher in cold water so storing the body of water at cold temperatures facilitates the dissolving of carbon dioxide into the body of water. The solubility of carbon dioxide is also much higher than other gases in air such as oxygen and nitrogen. Gas that is not dissolved into the body of water is able to be withdrawn from the absorption tank 102 via the gas outlet 110. Beneficially, the system 100 is able to capture carbon dioxide from atmospheric air in preference to other gases such as oxygen or nitrogen which are not required or desired to be captured.

The carbon dioxide capture system 100 comprises a cooler 108 arranged to maintain the body of water at or below atmospheric air temperature. The cooler 108 may be any suitable type depending on the low temperature requirement. For example, the cooler 108 may be a dry air cooler, a cooling tower or a chiller (e.g. a refrigerator). The cooler 108 may be separate from the absorption tank 102 or may be incorporated into the absorption tank 102. The absorption tank 102 may comprise cooling coils or an integrated heat pump evaporator.

The carbon dioxide capture system 100 further comprises a fluid outlet 112 via which the water may be withdrawn from the absorption tank 102. A first fluid delivery means 114 is arranged to withdraw water from the absorption tank 102 via the fluid outlet 112. The withdrawn water passes through a heat transfer unit 116 (a heat exchanger in this example) which allows for heat to be transferred to the water to raise the temperature of the water. The first fluid delivery means 114 in this example is a pump and may be, for example, a centrifugal pump or positive displacement pump.

The carbon dioxide capture system 100 further comprises a desorption tank 118 arranged to receive water from the absorption tank 102. The desorption tank comprises a fluid inlet 120 for receiving the water. The water is received via the heat transfer unit 116. The desorption tank 118 has a volume of between 10 m3 and 50 m3.

The water in the desorption tank 118 is stored at a higher temperature than the water stored in the absorption tank 102. The water is stored at a temperature of greater than 20 degrees Centigrade. The water is preferably stored at a temperature in the range of 20 degrees Centigrade to 60 degrees Centigrade.

The solubility of carbon dioxide decreases with temperature so the higher temperature of the water in the desorption tank 118 allows for the carbon dioxide to be released as a gas from the water.

The carbon dioxide capture system 100 further comprises a heater 122 arranged to maintain the temperature of the water in the desorption tank 118 at the higher temperature. The heater 122 may be separate to the desorption tank 118 or may be incorporated into the desorption tank 118. The desorption tank 118 may comprise heating coils or an integrated heat pump condenser.

The desorption tank 118 further comprises a fluid outlet 124 via which water is withdrawn from the desorption tank 118. The carbon dioxide capture system 100 further comprises a second fluid delivery means 126 arranged to withdraw water from the desorption tank 118 via the fluid outlet 124 for recirculation to the absorption tank 102. Advantageously, the water passes through the heat transfer unit 116 to allow for the return warm water to be cooled and the water flowing to the desorption tank 118 to be warmed. This heat regeneration improves the energy efficiency of the carbon dioxide capture system 100. The water is returned to the absorption tank 102 via a fluid inlet 130 of the absorption tank 102. The second fluid delivery means 126 in this example is a pump and may be, for example, a centrifugal pump or positive displacement pump.

The desorption tank 118 comprises a gas outlet 128 via which carbon dioxide gas may be withdrawn from the desorption tank 118. A gas delivery means 132 may be provided to withdraw gas from the desorption tank 118 via the gas outlet 128. The gas delivery means 132 may be a compressor. This concentrated carbon dioxide gas may be compressed into storage tanks for use in various applications or for long term storage.

In an example operation, atmospheric air is compressed by the fluid delivery means 106 and delivered to the absorption tank 102 via the gas inlet 104. The air is bubbled into the body of water through an internal network of perforated tubes to ensure good contact between the air and the water.

The cooler 108 maintains the body of water at a low temperature to facilitate the dissolving of carbon dioxide into the body of water. The water containing the dissolved carbon dioxide is withdrawn from the absorption tank 102 via the fluid outlet 112 and pumped through the heat transfer unit 116 by first fluid delivery means 114. The undissolved gas exits the absorption tank 102 via gas outlet 110.

The water is warmed in the heat transfer unit 116 by heat transfer from warmed water returning from the desorption tank 118. The water is further heated by the heater 112 to a temperature greater than 20 degrees Centigrade and delivered to the desorption tank 118 via fluid inlet 120. The higher temperature of the water in the desorption tank 118 allows for the carbon dioxide gas to be released from solution in the desorption tank 118. The carbon dioxide gas is released from the desorption tank 118 via gas outlet 128 and compressed by gas delivery means 132 into storage tanks.

The warmed water exits the desorption tank 118 via fluid outlet 124 and is pumped through the heat transfer unit 116 by second fluid delivery means 126. The water is cooled by heat exchange with the cooled water flowing from the absorption tank 102. The water is further cooled to a temperature of less than 25 degrees Centigrade by the cooler 108 and stored in the absorption tank 102.

Valves 134 are provided to control the flow of fluid and gas around the capture system 100.

It will be appreciated that in the carbon dioxide capture system 100 there is a first fluid circuit 136 which allows for water to flow from the absorption tank 102 to the desorption tank 118 and a second fluid circuit 138 (return fluid circuit 138) that allows for water to flow from the desorption tank 118 to the absorption tank 102. The first fluid circuit 136 and the second fluid circuit 138 both pass through the heat transfer unit 116 to allow for heat exchange. The first fluid circuit 136 and the second fluid circuit 138 are separate circuits such that water in the first fluid circuit 136 is separated from the second fluid circuit 138 and is unable to mix with water in the second fluid circuit 138. Water is able to pass from one of the first fluid circuit 136 and the second fluid circuit 138 to the other of the first fluid circuit 136 and the second fluid circuit 138 via the absorption tank 102 and desorption tank 118.

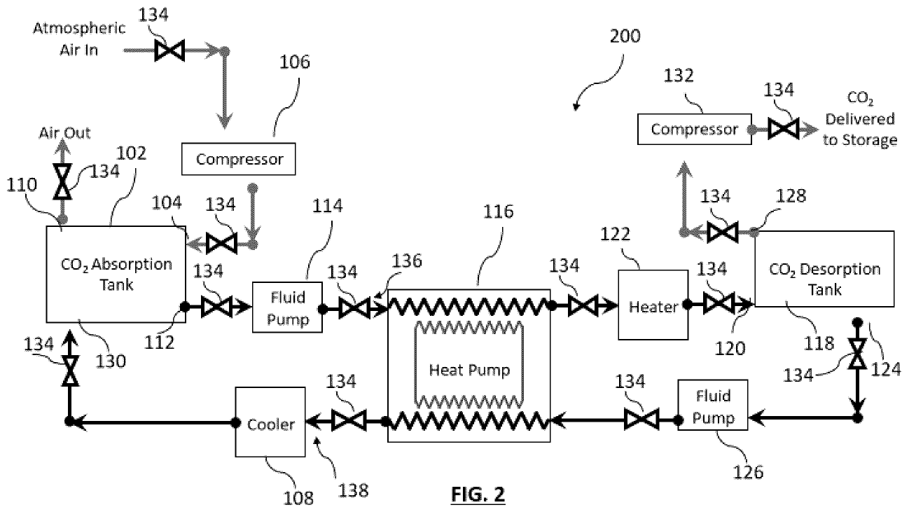

FIG. 2 shows another example carbon dioxide capture system 200 according to aspects of the present disclosure. The carbon dioxide capture system 200 is similar to the system 100 shown in FIG. 1 and like references are used to indicate like components.

In this example, the heat transfer unit 116 is in the form of a heat pump. The use of a heat pump assists in the absorption tank 102 to operate at temperatures below air temperature. This is beneficial as solubility, and hence absorption rate, is higher at lower temperatures. Heat pumps may comprise components such as liquid to refrigerant heat exchangers, pipework, joints and valves for refrigerant flow, a refrigerant compressor and accumulator, pipework, joints and valves for pumping flow, and a heat pump control and monitoring system.

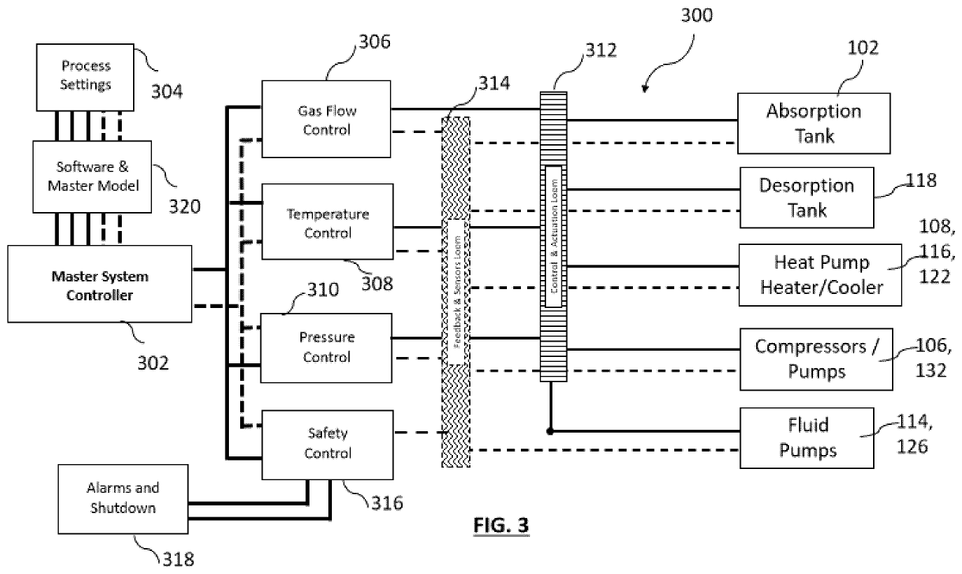

Advantageously, the carbon dioxide capture systems 100, 200 described above in relation to FIGS. 1 and 2 are able to achieve high energy efficiency by lowering the operating temperatures for carbon dioxide absorption, regenerating heat energy from the warmed water, and by controlling the operating temperatures of the absorption tank 102 and the desorption tank 118. A control system as described below in relation to FIG. 3 can enable precise control of the operating temperatures to maximise energy efficiency.

In preferred examples, the temperature of the water in the desorption tank 118 is only required to be heated to a temperature of at most 60 degrees Centigrade and can be at most 50 degrees Centigrade. Low grade heat taken from heat recovery system(s) can be used to heat the water providing for high energy efficiency. Geothermal energy can also be used to heat the water. Other sources of waste heat can also be used to heat the water, for example heat generated from the industrial process off gas/flue gas (e.g., steel manufacture, glass manufacture, cement manufacture, polymer and composite manufacture, chemical production, metal casting, injection moulding, or other processes where waste heat is available at 70 C plus), thermocyclic hydrogen production, steam reforming for hydrogen production, fuel production, nuclear power plants, or other hydrogen production or associated activities.

It will be appreciated that not all of the components shown in the examples of FIGS. 1 and 2 are required in all examples.

For example, advantageous effects can still be achieved without providing the desorption tank for releasing carbon dioxide gas captured into the water. In this example, water contained carbon dioxide gas can exit the absorption tank without passing through the recirculation circuit comprising the heat transfer unit, desorption tank and other components as described above. In a particular use case, the carbon dioxide capture system may be deployed at an off-shore site. Sea water can flow into the absorption tank and be used to capture carbon dioxide. The sea water can then be returned to the sea. The carbon dioxide capture system can ideally be installed at an off-shore wind farm facility to use excess energy from the wind farm to cool the water in the absorption tank.

FIG. 3 shows a control system 300 used to control and/or monitor the operation of the carbon dioxide capture system 100, 200 according to aspects of the present disclosure. In the Figure, solid lines indicate control signals and dashed lines indicate feedback and/or sensor signals.

The control system 800 typically comprises a master system controller 302 which is typically implemented by one or more suitable programmed or configured hardware, firmware and/or software controllers, e.g. comprising one or more suitable programmed or configured microprocessor, microcontroller or other processor, for example an IC processor such as an ASIC, DSP or FPGA (not illustrated).

In preferred examples, the control system 300 communicates control information to other components of the system such as valves 134, fluid delivery means 114, 126, gas delivery means 106, 132, cooler 108 and heater 122. Process settings may be received via a process setting interface unit 404. The process settings may specify environmental conditions, for example in relation to temperature(s), flow rate(s), and/or pressure(s).

In the example shown in FIG. 3, a gas flow control module 306 generates control signals for controlling the gas flow rate, a temperate control module 308 generates control signals for controlling the temperature, a pressure control module 310 generates control signals for controlling the pressure. The control signals are supplied to a control and actuation loom 312 which routes the control signals to the desired components of the carbon dioxide capture system.

The control system 300 may also receive feedback information from other components such as sensors (e.g. incorporated into the absorption tank 102 and/or desorption tank 118), measurement devices (e.g. incorporated into the absorption tank 102 and/or desorption tank 118), valves 134, fluid delivery means 114, 126, gas delivery means 106, 132, cooler 108 and heater 122, in response to which the control system 800 may issue control information to one or more relevant components. The feedback information is received via a feedback and sensor loom 314 in this example.

The control system 300 may perform analysis of the measurements or other information provided. This analysis may be carried out automatically in real time by the control system 300. Alternatively, or in addition, analysis of the system measurements and performance may be made by an operator in real time or offline. The operator may make adjustments to the operation of the carbon dioxide gas capture system by providing control instructions via the process settings interface 304.

A safety control module 316 may be provided, which may receive alarm signals from one or more alarm sensors (not shown), e.g. gas sensors, temperature sensors, leak detectors or emergency stops that may be included in the carbon dioxide gas capture system. The safety control module 316 provides alarm information to the master controller 302 based on the alarm signals received from the alarm sensors. The safety control module 316 may also control an alarm and shutdown module 318 to generate an alarm for the operator and/or shutdown the operation of carbon dioxide gas capture system.

In preferred examples, the control system 300, and more particularly the master controller 302 is configured to implement system modelling logic, e.g., by supporting mathematical modelling software or firmware 320, for enabling the control system 300 to mathematically model the behaviour of the carbon dioxide capture system, depending on the process settings and/or on feedback signals received from one or more system components during operation of the carbon dioxide gas capture system.

Optionally, the control system 300 is configured to implement Model Predictive Control (MPC). Using MPC, the control system 300 causes the control action of the control modules 306, 308, 310, 316 to be adjusted before a corresponding deviation from a relevant process set point actually occurs. This predictive ability, when combined with traditional feedback operation, enables the control system 300 to make adjustments that are smoother and closer to the optimal control action values that would otherwise be obtained. A control model can be written in Matlab, Simulink, or Labview by way of example and executed by the master controller 302. Advantageously, MPC can handle MIMO (Multiple Inputs, Multiple Outputs) systems.

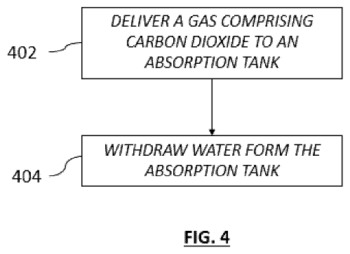

FIG. 4 shows an example method of capturing carbon dioxide according to aspects of the present disclosure. Step 402 comprises delivering gas comprising carbon dioxide to an absorption tank storing a body of water to allow for carbon dioxide to dissolve into the body of water. Step 404 comprises withdrawing water comprising dissolved carbon dioxide from the absorption tank.

In summary, there is provided a carbon dioxide capture system 100, 200 and method of capturing carbon dioxide. The carbon dioxide capture system 100, 200 comprises an absorption tank 102 arranged to store a body of water. The absorption tank 102 comprises a gas inlet 104 via which gas (e.g. atmospheric air) is delivered to the tank 102 to allow for carbon dioxide contained within the gas to dissolve into the body of water. The system 100, 200 further comprises a first fluid delivery means 114 arranged to withdraw water from the absorption tank 102. The withdrawn water may be delivered to a desorption tank 118 via a heat transfer unit 116 to allow for the withdrawn water to be heated to a higher temperature. A heater 122 may also raise the temperature of the water further. The warmed water releases carbon dioxide gas into the desorption tank 118. The carbon dioxide gas may be withdrawn from the desorption tank 118 and stored.

Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A carbon dioxide capture system comprising:
an absorption tank arranged to store a body of water, the absorption tank comprising a gas inlet via which gas is delivered to the tank to allow for carbon dioxide contained within the gas to dissolve into the body of water;
a first fluid delivery means arranged to withdraw water from the absorption tank; and
a heat transfer unit comprising a connection means for receiving heat from another process.

2. A carbon dioxide capture system as claimed in claim 1, wherein the gas is atmospheric air or any carbon dioxide containing gas mixture.

3. A carbon dioxide capture system as claimed in claim 1, wherein the absorption tank has a volume of at least 1 m3.

4. A carbon dioxide capture system as claimed in claim 1, further comprising a gas delivery means arranged to deliver the gas to the tank via the gas inlet.

5. A carbon dioxide capture system as claimed in claim 1, wherein the body of water is stored at a temperature of less than 35 degrees Centigrade.

6. A carbon dioxide capture system as claimed in claim 5, wherein the body of water is stored at a temperature of less than 20 degrees Centigrade.

7. A carbon dioxide capture system as claimed in claim 5, further comprising a cooler arranged to maintain the body of water at a temperature of less than 35 degrees Centigrade.

8. A carbon dioxide capture system as claimed in claim 7, wherein the cooler is incorporated into the absorption tank.

9. A carbon dioxide capture system as claimed in claim 1, wherein the heat transfer unit arranged to receive water from the first fluid delivery means and transfer heat to the water to raise the temperature of the water.

10. A carbon dioxide capture system as claimed in claim 9, wherein the heat transfer unit comprises a heat exchanger.

11. A carbon dioxide capture system as claimed in claim 1, further comprising a desorption tank arranged to receive water from the absorption tank to allow for carbon dioxide gas to be released from the water.

12. A carbon dioxide capture system as claimed in claim 11, further comprising a second fluid delivery means arranged to withdraw water from the desorption tank for recirculation to the absorption tank.

13. A carbon dioxide capture system as claimed in claim 12, further comprising a heat transfer unit arranged to receive water from the first fluid delivery means and water from the second fluid delivery means, wherein the heat transfer unit is arranged to allow for heat from the water received from the second fluid delivery means to be transferred to the water received from the first fluid delivery means.

14. A carbon dioxide capture system as claimed in claim 11, wherein the water in the desorption tank is stored at a temperature greater than that of the water stored in the absorption tank.

15. A carbon dioxide capture system as claimed in claim 14, wherein the water in the desorption tank is stored at a temperature of greater than 20 degrees Centigrade.

16. A carbon dioxide capture system as claimed in claim 14, further comprising a heater arranged to maintain the temperature of the water in the desorption tank at a temperature of greater than 20 degrees Centigrade.

17. A carbon dioxide capture system as claimed in claim 14, further comprising a heater arranged to maintain the temperature of the water in the desorption tank at a temperature greater than water stored in the absorption tank.

18. A carbon dioxide capture system as claimed in claim 17, wherein the heater is incorporated into the desorption tank.

19. A carbon dioxide capture system as claimed in claim 11, further comprising a gas delivery means arranged to withdraw gas from the desorption tank.

20. A method of capturing carbon dioxide, the method comprising:
delivering gas comprising carbon dioxide to an absorption tank storing a body of water to allow for carbon dioxide to dissolve into the body of water;
withdrawing water comprising dissolved carbon dioxide from the absorption tank; and
receiving heat from another process via a heat transfer unit comprising a connection means.

21. A method as claimed in claim 20, wherein the gas is atmospheric air.

22. A method as claimed in claim 20, further comprising maintaining the body of water at a temperature of less than 25 degrees Centigrade.

23. A method as claimed in in claim 20, further comprising delivering the water withdrawn from the absorption tank to a heat transfer unit to allow for heat to be transferred to the water.

24. A carbon dioxide capture system comprising:
a desorption tank comprising a fluid inlet arranged to receive water comprising captured carbon dioxide; and
a heater arranged to heat the water to a temperature to allow for carbon dioxide to be released from the water,
wherein the desorption tank comprises a gas outlet via which carbon dioxide gas may be withdrawn from the desorption tank.
